(19) United States
(12) Patent Application Publication
(10) Pub. No.: US 2009/0138761 A1
(43) Pub. Date: May 28, 2009

(54) System and method for electronic testing of devices

(76) Inventor: Jose Moreira, (US)

Correspondence Address: FAY KAPLUN & MARCIN, LLP, 150 BROADWAY, SUITE 702, NEW YORK, NY, 10038, US

(21) Appl. No.: 11/998,084

(22) Filed: Nov. 28, 2007

(51) Int. Cl. G06F 11/00

(52) U.S. Cl. 714/32

(57) ABSTRACT

A coupler and associated method electronically tests devices. The method comprises receiving a stimulus signal for testing the electronic device, receiving an aggressor signal, injecting the aggressor signal into the stimulus signal to create a resultant signal that is the stimulus signal having a jitter, and sending the resultant signal to the electronic device. The coupler comprises an input port to receive a stimulus signal for testing the electronic device, an injection device to inject an aggressor signal into the stimulus signal to create a resultant signal that is the stimulus signal having a jitter, and an output port to output the resultant signal to the electronic device.

### BACKGROUND

A newly manufactured electronic device is tested by sending stimulus signals to the device and capturing responses. These measurements may be used to, for example, measure actual performance against expected performance. The electronic device may receive the stimulus signal to trigger the device under test (DUT). For example, the stimulus signal may include data that when received by the DUT, initiates a sequence of actions to be performed. The stimulus signal may be generated from a stimulus source that electrically connects to a pin of the electronic device.

When testing a newly manufactured electronic device, a measurement of the ability of the DUT to deal with unexpected timing variations known as timing jitter may be valuable. Thus, to measure this ability, a signal may be created that includes artificial timing variations to simulate timing jitter. The signal may be created using a separate pin of the testing apparatus. However, this results in added cost to add this feature to the testing apparatus and does not allow for an easy retrofit of testing apparatuses that do not currently have this feature because the entirety of the electronics would need to be replaced. A filter may be used to inject jitter on the stimulus signal to alleviate the use of a second pin. The filter automatically creates a jitter when the stimulus signal passes through it. However, the filter always adds a jitter to the stimulus signals and this results in a degraded stimulus signal for other types of test that need a clean stimulus signal.

### SUMMARY OF THE INVENTION

The present invention relates to a method for electronic testing of devices. The method comprises receiving a stimulus signal for testing the electronic device, receiving an aggressor signal, injecting the aggressor signal into the stimulus signal to create a resultant signal that is the stimulus signal having a jitter, and sending the resultant signal to the electronic device.

The present invention further relates to a coupler for electronic testing of devices. The coupler comprises an input port to receive a stimulus signal for testing the electronic device, an injection device to inject an aggressor signal into the stimulus signal to create a resultant signal that is the stimulus signal having a jitter, and an output port to output the resultant signal to the electronic device.

### DESCRIPTION OF THE DRAWINGS

FIG. 1 shows an exemplary embodiment of a system according to the present invention.

FIG. 2 shows an exemplary embodiment of a method according to the present invention.

### DETAILED DESCRIPTION

The present invention may be further understood with reference to the following description and the appended drawings, wherein like elements are referred to with the same reference numerals. The exemplary embodiments of the present invention provide a system and method for performing an electronic test on an electronic device. The exemplary embodiments of the present invention will be described with reference to the electronic test utilizing a stimulus signal with an injected jitter. The stimulus signal with injected jitter will be described in detail below. The following exemplary embodiments describe a testing device that measures a single electronic device. However, those skilled in the art will understand that the present invention may also apply to testing devices that are capable of measuring multiple electronic devices concurrently. It should be noted that the term “electronic device” may also include optical devices.

It should also be noted that, as will be described in detail below, an aggressor signal is used to inject the jitter into the stimulus signal. In some instances, it is stated in this description that the aggressor signal is injected into the stimulus signal. This does not mean that it is a requirement that the aggressor signal is directly injected into the stimulus signal. While such a direct injection may occur, the present invention is not limited to direct injection. The injection of the aggressor signal means that the aggressor signal is used to introduce jitter into the stimulus signal, whether the manner of introducing this jitter is direct injection of the aggressor signal or some other manner. Thus, the term “inject” or its variants whether used to describe the aggressor signal or the jitter is not limited to a direct combination of two signals.

When the electronic device is used in actual scenarios, the device may be required to tolerate unexpected changes on the timing of received signals (i.e., timing jitter). Timing jitter is an abrupt and unwanted variation of one or more signal characteristics such as the interval between successive pulses, the amplitude of successive pulses, the frequency or phase of successive pulses, etc. Timing jitter may be caused by a variety of reasons such as random noise inherent to any semiconductor based electronic device (e.g., shot noise, Johnson noise, etc.) and the timing changes due to the signal loss from a transmission line used to transmit the signal. That is, the electronic device may always be susceptible to a timing jitter. Thus, simulating jitter in a testing environment is an integral part of the design of any electronic device. By simulating as many possible scenarios in a testing phase of an electronic device, performance measurements may assist in designing the electronic device. By thoroughly testing an electronic device through various jitter conditions, the capabilities of the electronic device may be fully understood, thereby determining if the electronic device operates in compliance with a standard and/or a manufacturer specification.

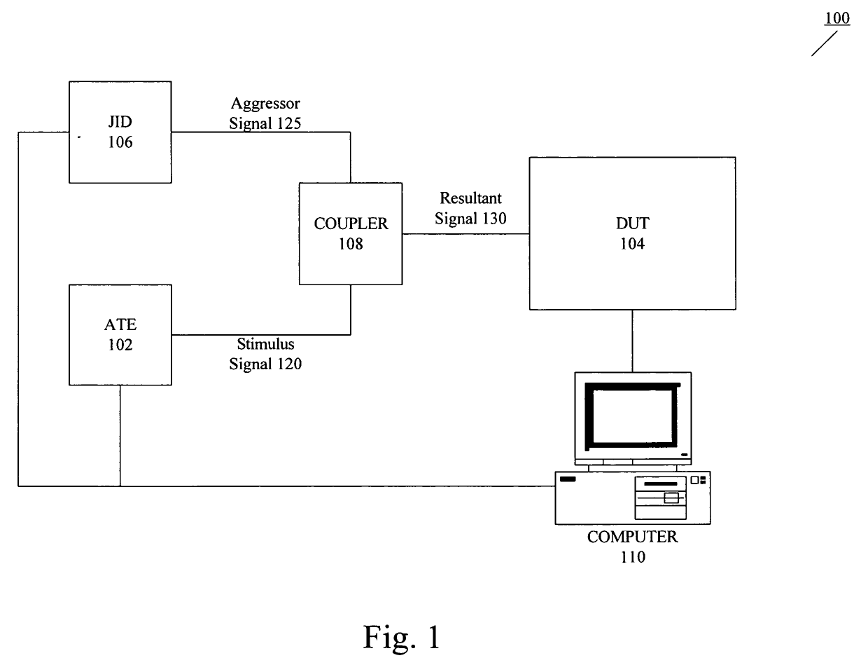

FIG. 1 shows an exemplary embodiment of a system 100 according to the present invention. The system 100 may be for performing a test on an electronic device. The test may be for various types of electronic devices and may, therefore, include the various tests performed for the different types of electronic device. For example, with devices intended for trans-oceanic communications using fiber-optic lines, an appropriate stimulus signal to test the ability of the device to tolerate timing jitter may include a sinusoidal low-frequency high-amplitude timing jitter component. This may simulate the jitter that the signal in a real application may have experience to the effect of variations in temperature through a long transmission line. The amount of jitter that the communications device must tolerate may be defined in an industry specific standard such as ITU SONET standard. The exemplary embodiments of the present invention incorporates the various tests for the various types of electronic devices.

The system 100 includes an automatic test equipment (ATE) device 102 and a jitter injection device (JID) 106 which are electrically connected to a coupler 108. The coupler 108 is electrically connected to a device under test (DUT) 104. An exemplary coupler 108 will be described in greater detail below. The system 100 may further include a computer 110 (e.g., PC, laptop, tablet, etc.) which may be coupled to the DUT 104, the JID 106, and/or the ATE device 102. The computer 110 (or any of the DUT 104, the JID 106, and/or the ATE device 102) may include a memory storing a set of instructions for implementing the electronic test. The computer 110 may include an output device, e.g., display screen, printer, etc., for outputting results of the electronic test. It should be noted that the use of a single ATE device 102 is only exemplary. Those skilled in the art will understand that multiple ATE devices may be electrically coupled directly to the DUT 104 or indirectly through the coupler 108. These other ATE devices may further be connected to the computer 110. For example, with frequency offset tests, one ATE device may include transmit and receive lines for data transmission/reception. Another ATE device may include a clock to time the different data transfers.

In the exemplary embodiment, the DUT 104 may be any electronic device (e.g., video card, sound card, high speed memory device, etc.). In most cases, the DUT 104 purports to operate in accordance with a specification such as the PCI-Express specification, IEEE specification, etc. and the testing may be based on these specifications. The DUT 104 may implement, for example, a System-on-a-Chip (SoC) or a System-in-a-Package (SIP) architecture. The ATE device 102 may be SoCs which include a microprocessor, memory and a plurality of application specific integrated circuits (ASICs) implementing a test-per-pin architecture in which each pin of the DUT 102 may be tested independently. For example, the ATE device 102 may be for digitally testing channels. The ATE device 102 measures parametric performance measurements pertaining to the DUT 104. This data may be transmitted to the computer 106 for storage and/or processing.

In the exemplary embodiment, the ATE 102 generates the stimulus signal 120 and the JID 106 may generate an aggressor signal 125 that is a source of jitter. The JID 106 may control the amount of jitter to be injected into the stimulus signal 120 generated by the ATE device 102. The amount of jitter may be controlled by an input received from the computer 110 that transmits the desired level of jitter to the JID 106 which, in turn, generates the corresponding aggressor signal 125. The coupler 108 may be an injection device that combines the stimulus signal 120 from the ATE device 102 with the aggressor signal 125 from the JID 106 creating the resultant signal 130. The stimulus signal may be received using an input port of the coupler 108 while the aggressor signal may be receiving using a second input port of the coupler 108. The resultant signal 130 (e.g., the stimulus signal 120 with the injected aggressor signal 125) may then be forwarded to the DUT 104 for testing purposes using, for example, an output port of the coupler 108. Thus, in the exemplary embodiment, the resultant signal 130 may include any amount of jitter injected into the stimulus signal 120 based on the aggressor signal 125 or may be the clean stimulus signal 120 if no aggressor signal 125 is generated by the JID 106.

In one exemplary embodiment, the coupler 108 is disposed on a printed circuit board (PCB) that is used to connect the ATE 102 to the DUT 104. In such an embodiment, the ability to test the DUT 104 using the jitter signal is accomplished without altering the ATE 102 or the DUT 104 in any manner. Thus, an ATE 102 that does not include the ability to test using a jitter signal may be used to perform tests that require jitter without any modification to the ATE 102.

The coupler 108 may inject the aggressor signal 125 in the stimulus signal 120 in any manner that produces the desired amount of jitter in the resultant signal 130. For example, the lead carrying the stimulus signal 120 and the lead carrying the aggressor signal 125 may be located in close proximity to each other on the PCB causing interference between the signals 120 and 125 (e.g., inductive currents, eddy currents, etc.) resulting in the stimulus signal 120 including jitter. However, those skilled in the art will understand that there may be other manners of injecting the jitter using electrical coupling based on mechanical coupling (e.g., twisting the leads, etc.) or by using separate electronic components such as switches, operational amplifiers, etc.

It should be noted that showing the JID 106 disposed as a separate unit from the ATE 102 is only exemplary. For example, the ATE 102 may also generate the aggressor signal 125 that is used to inject the jitter into the stimulus signal 120. In such an example, the ATE 102 would include the functionality of the JID 106. It should further be noted that showing the JID 106 and the coupler 108 disposed as separate units is only exemplary. For example, the JID 106 may be incorporated into the coupler 108 (e.g., the coupler 108 and the JID 106 both reside on the PCB). In another embodiment, the functionality of the JID 106 and coupler 108 may be included in the ATE 102 (e.g., by adding a separate coupler 108 PCB to the ATE 102). In such an embodiment, the resultant signal 130 (e.g., clean stimulus signal or jitter injected signal) will be output by the ATE 102. However, it will still only require a single pin of the ATE 102 and may include either the clean signal or the jitter injected signal.

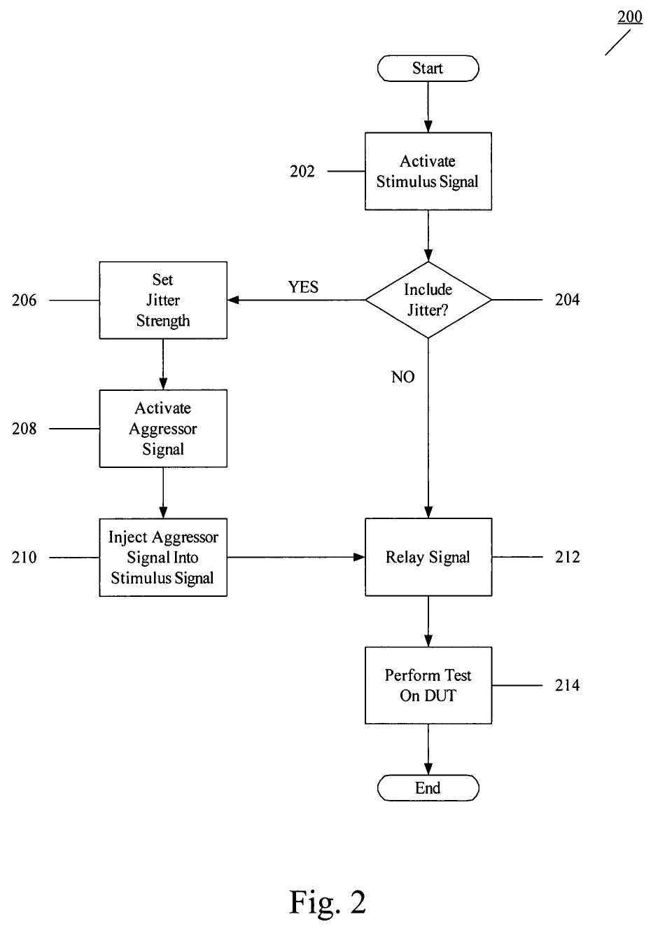

FIG. 2 shows an exemplary embodiment of a method 200 according to the present invention. The method 200 describes a test for an electronic device that utilizes either a clean stimulus signal or a stimulus signal with an injected aggressor signal. The stimulus signal with an injected aggressor signal provides a cost efficient (e.g., use of a single pin on the DUT 104 and the ATE 102) method to test an electronic device with various degrees of jitter. The method 200 will be described with reference to the system 100 of FIG. 1.

In step 202, a stimulus signal 120 is activated. The stimulus signal 120 may originate from the ATE device 102. As discussed above, the stimulus signal 120 is used to test the DUT 104 by activating a functionality (e.g., input a type of data related to the functionality) the DUT 104 purports to be able to execute in compliance with, for example, an industry standard, a manufacturer specification, etc.

In step 204, a determination is made whether to inject a jitter into the stimulus signal 120. As discussed above, utilizing a variety of stimulus signals with various jitter strengths allow for a thorough testing of the DUT 104. Also, as discussed above, scenarios exist where the DUT 104 is tested with the absence of a jitter. For example, a manufacturer may desire to ascertain an optimal performance measurement. The optimal performance measurement is likely to occur when one of the conditions is the complete absence of any jitter. If the stimulus signal 120 with no jitter (e.g., a “clean” stimulus signal) is used to test the DUT 104, then the method 200 continues to step 212 where the resultant signal 130 (i.e., the clean stimulus signal 120) is relayed to the DUT 104. As described above, an advantage of the exemplary embodiment of FIG. 1 is that it allows for testing of the DUT 104 with the clean stimulus signal or a jitter injected stimulus signal.

If it is determined that the stimulus signal 120 is to include a jitter, the method 200 continues to step 206. In step 206, the jitter strength is set. For thorough testing, multiple jitter strengths may be used to determine the capabilities of the DUT 104. Thus, setting a jitter strength allows the manufacturer to maintain, for example, a database with the various responses to the different jitters. As discussed above, the manufacturer may set the jitter strength by inputting data into the computer 110 that relays this data to the JID 106. In another embodiment, the JID 106 may include an interface such as a dial, keypad, etc. to set the jitter strength.

In step 208, the aggressor signal 125 is activated. The aggressor signal 125 may originate from the JID 106. As discussed above, the aggressor signal 125 may be any signal that controls an amount of jitter that is to be injected into the stimulus signal 120 to simulate scenarios in which the DUT 104 may function. It should again be noted that the use of a separate JID 106 is only exemplary and the aggressor signal 125 may also originate from the ATE 102 if the ATE 102 is capable of further generating the aggressor signal 125.

In step 210, the aggressor signal 125 is injected into the stimulus signal 120. The aggressor signal 125 may be injected into the stimulus signal 120 using the coupler 108 to generate the resultant signal 130. The coupler 108 may be configured to inject the aggressor signal 125 in a variety of ways. For example, the coupler 108 may be configured to allow the coupling of signals in a specific frequency bandwidth, thereby limiting the frequency of the jitter being injected in the resultant signal 130 by the coupler 108. In another example, the coupler 108 may be configured to control an amount of injected jitter by controlling an amount of coupling between the stimulus signal 120 and the aggressor signal 125. It should be noted that the actual aggressor signal 125 may also be carried to produce the above described resultant signals 130.

In step 212, the resultant signal 130 is relayed. Depending on the architecture of the testing system, the signal relay may be done in various ways. For example, as illustrated in system 100 of FIG. 1, the signal is relayed to the DUT 104 by the coupler 108 after the coupler 108 first receives the stimulus signal 120 and the aggressor signal 125. Whether the signal is the clean stimulus signal 120 or the stimulus signal 120 with injected aggressor signal 125 (as determined from step 204), the appropriate resultant signal 130 may be relayed to the DUT 104. Thus, in step 214, the test may be performed on the DUT 104 using the appropriate resultant signal 130.

It should be noted that the method 200 may include additional steps. For example, the method 200 may be designed to compare the results of the test to the standard and/or the manufacturer specification. Thus, the method 200 may include a step where the standard and/or the manufacturer specification is loaded. Upon performing the test at step 214, an alert may be displayed on the output device of the computer 110 indicating whether the DUT 104 passed or failed the electronic test.

It should also be noted that the stimulus signal 120 and the aggressor signal 125 being activated at different times is only exemplary. The method 300 may place the jitter strength setting step prior to the activation of the stimulus signal 120 (i.e., step 202). Thus, upon setting the jitter strength, the stimulus signal 120 and the aggressor signal 125 may be activated concurrently to create the resultant signal 130 having the stimulus signal 120 with injected aggressor signal 125. This resultant signal 130 may then be relayed to the DUT 104 for testing. This embodiment may set the jitter strength to zero so that no determination be made at step 204. Therefore, the resultant signal 130 may be equivalent to the stimulus signal 120 (e.g., the clean stimulus signal).

Those skilled in the art will understand that the exemplary embodiments of the present invention may also be applied to components of electronic devices as well. That is, the use of a finalized electronic device (i.e., complete manufacture) is only exemplary. For example, a finalized component of the electronic device may be the “DUT” where various constituent parts are the “components.” Thus, applying the exemplary system and method described above, the configuration of components may also be tested.

Those skilled in the art will also understand that the above described exemplary embodiments may be implemented in any number of manners, including, as a separate software module, as a combination of hardware and software, etc. For example, the method 200 may be a program containing lines of code that, when compiled, may be executed on a processor of the computer 110.

The present invention allows the DUT 104 to be tested using a single pin. Furthermore, the present invention also allows jitter to be included or excluded. Thus, the present invention provides a cost efficient system and method for testing an electronic device in various jitter conditions. The manufacturer may select when and how to include the jitter into the stimulus signal. Therefore, the present invention eliminates the need for additional components such as the buffer (which is restricting) and retains the benefits of using the additional component (single pin). The manufacturer may also use a “clean” signal with no jitter.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a stimulus signal for testing an electronic device;
receiving an aggressor signal;
injecting the aggressor signal into the stimulus signal to create a resultant signal that is the stimulus signal having a jitter; and
sending the resultant signal to the electronic device.

2. The method of claim 1, further comprising:
setting a strength of the aggressor signal.

3. The method of claim 2, wherein the strength of the aggressor signal may be one of zero and non-zero.

4. The method of claim 1, wherein the stimulus signal is received from an automatic test equipment device.

5. The method of claim 4, wherein aggressor signal is received from the automatic test equipment device.

6. The method of claim 1, wherein the aggressor signal is received from a jitter injection device.

7. The method of claim 4, wherein the aggressor signal is injected in the stimulus signal by a coupler device.

8. The method of claim 7, wherein the coupler device is disposed as one of a separate unit and a portion of a printed circuit board interposed between the automatic test equipment device and the electronic device.

9. The method of claim 1, further comprising:
outputting results of a test on an output device.

10. A coupler device, comprising:
an input port receiving a stimulus signal for testing an electronic device;
an injection device injecting an aggressor signal into the stimulus signal to create a resultant signal that is the stimulus signal having a jitter; and
an output port outputting the resultant signal to the electronic device.

11. The coupler device of claim 10, further comprising:
a determination device determining a strength of the aggressor signal.

12. The coupler device of claim 11, wherein the strength of the aggressor signal may be one of zero and non-zero.

13. The coupler device of claim 10, wherein the stimulus signal is received from an automatic test equipment device.

14. The coupler device of claim 13, wherein the aggressor signal is received from the automatic test equipment device.

15. The coupler device of claim 10, further comprising:
a second input port receiving the aggressor signal.

16. The coupler device of claim 10, further comprising:
a signal generator generating the aggressor signal.

17. The coupler device of claim 13 being disposed as one of a separate unit and a portion of a printed circuit board interposed between the automatic test equipment device and the electronic device.

18. The coupler device of claim 10, further comprising:
an output device to display results of a test.

19. A system, comprising:
an automatic test equipment device generating a stimulus signal;
a jitter injection device generating an aggressor signal; and
a coupler device receiving the stimulus signal and the aggressor signal to inject the aggressor signal into the stimulus signal, thereby creating a resultant signal that is the stimulus signal having a jitter for testing an electronic device.

20. The system of claim 18, wherein the jitter injection device is a part of the automatic test equipment device.

21. The system of claim 18, wherein the coupler device is disposed as one of a separate unit and a portion of a printed circuit board interposed between the automatic test equipment device and the electronic device.
